(19) United States
(12) Patent Application Publication
(10) Pub. No.: US 2005/0049910 A1
(43) Pub. Date: Mar. 3, 2005

(54) System and method for management interface for clinical environments

(75) Inventors: Brian J. Lancaster, Merriam, KS (US); Kent D. Parkins, Parkville, MO (US); Michael E. Yarbrough, Lee's Summit, MO (US)

Correspondence Address: SHOOK, HARDY & BACON L.L.P., 2555 GRAND BOULEVARD, KANSAS CITY, MO, 64108-2613, US

(73) Assignee: Cemer Innovation, Inc., Overland Park, KS (US)

(21) Appl. No.: 10/834,229

(22) Filed: Apr. 29, 2004

Related U.S. Application Data
(60) Provisional application No. 60/508,273, filed on Oct. 6, 2003.
(60) Provisional application No. 60/498,283, filed on Aug. 28, 2003.

(51) Int. Cl. G06F 17/60

(52) U.S. Cl. 705/10; 705/7; 705/2

(57) ABSTRACT

A system and method for a management interface for clinical environments presents aggregated clinical, financial, operational and other data to administrators and other users. Clinical or department lines and other groupings may be presented in graphical representations of patient outcomes, costs, drug and other therapies and other indicators. Outcomes and other benchmarks may be selectively compared against historical trends or known medical benchmarks, and in embodiments scenario modeling based on alternative therapies, procedures or other variables may be presented. The clinical and other source data from which the graphical interfaces may be presented may be generated via data warehouse platforms including grouping engines which process originally captured data into extended, pre-grouped or pre-related dimensions. A closed feedback loop between current operational outcomes, baseline recommended therapies and adjusted treatment plans may in embodiments be established to permit rigorous tracking and improvement in benchmarks of interest.

### CROSS REFERENCE TO RELATED APPLICATIONS

The subject matter of this application is related to the subject matter of co-pending U.S. Provisional Patent Application Ser. No. 60/508,273 filed Oct. 6, 2003 entitled “System and Method for Management Interface for Clinical Environments”, assigned or under obligation of assignment to the same entity as this application, which application is incorporated by reference, and from which application priority is claimed; and to the subject matter of co-pending U.S. Provisional Patent Application Ser. No. 60/498,283 filed Aug. 28, 2003 entitled “System and Method for Multidimensional Extension of Database Information”, and of co-pending U.S. patent application Ser. No. 10/665,560 filed Sep. 22, 2003 entitled “System and Method for Multidimensional Extension of Database Information”, each of which applications is assigned or under obligation of assignment to the same entity as this application, and each of which is incorporated by reference.

### FIELD OF THE INVENTION

The invention relates to the field of medical information technology, and more particularly to a platform configured to analyze medical, financial or other clinically related data and visualize and manage related outcomes through an interface capable of presenting multiple categories of such data on a commonly grouped scale, along with standards-based alerts, selectable performance indicators and other metrics, options and displays.

### BACKGROUND OF THE INVENTION

Medical information platforms have expanded in range and sophistication, and now permit physicians, managers, administrators, researchers and others to capture a wide range of clinical data from hospital, research, government and other operations. For example, in a clinical hospital setting, data regarding patient intake, treatment and outcomes by department or specialty may be collected for analysis. The cardiac treatment team may for example record data on patient encounters and treatments including, for instance, total admissions for myocardial infarctions, congestive heart disease and other clinical diagnoses, and track the treatment provided to those patients, such as bypass procedures, prescribed drugs such as beta blockers, statins or others, or other treatments or procedures, as well as the eventual patient outcomes for patients receiving those treatments.

However, capturing even a wide range of data by itself may still not permit administrators to control or enhance clinical operations with an optimal degree of flexibility or precision. As one drawback on conventional interfaces, the operational data and clinical outcomes may be comprehensively presented but not in connection with or related to the clinical treatments or contexts which produced them. For instance, a given survival rate for second heart attack patients may be reported in chart or table form, but reports or correlations on the drug or surgical treatments they received may not, or not in a readily visualized or selective manner.

Furthermore, clinical outcomes may not be compared against known medical guidelines or standards, visually or otherwise. That is, patient morbidity, mortality and other outcomes may not be assessed against recommended therapeutic protocols to determine if medical care givers are adhering to best available practices, or pursuing recommended alternatives. Furthermore, the data which is provided may be presented in different scales or formats, with no unifying baseline for all categories of data to permit high-level visualization of combined performance. Other shortcomings in conventional clinical tracking and management systems exist.

### SUMMARY OF THE INVENTION

The invention overcoming these and other problems in the art relates in one regard to a system and method for a management interface for managing clinical environments in which admission, diagnosis, treatment, outcome and other data may be captured from one or more departments or other treatment groups in a hospital or other facility. According to the invention in one regard, clinical outcomes may be aggregated and subjected to a variety of metrics, including morbidity, mortality, financial and other medical or operational results. According to embodiments of the invention in another regard, those outcomes may be further related to known protocols or other standards, to model and predict how selective differences in drug, surgical or other treatments may alter or improve outcomes or other metrics. Various metrics may also be related between themselves, to commonly visualize and assess for instance the interplay or comparison between costs, patient stays, drug dosing or other parameters may affect clinical and other outcomes. All data and views may be presented in a unified interface with commonly grouped or normalized scales. The modeling scenarios may be presented to an administrator or other user in a graphical or other user interface, permitting a manager to run predictive simulations of alternative treatment plans, to drill into key performance indicators and view graphical representations of those results.

### BRIEF DESCRIPTION OF THE DRAWINGS

The invention will be described with reference to the accompanying drawings, in which like numbers reference like elements.

FIG. 1 illustrates a network environment in which embodiments of the invention may operate.

FIG. 2 illustrates a graphical user interface with selective clinical display according to an embodiment of the invention.

FIG. 3 illustrates a graphical user interface with selective clinical display according to another embodiment of the invention.

FIG. 4 illustrates a flowchart of clinical management processing according to an embodiment of the invention.

FIG. 5 illustrates a click-through feature for activating further table or other data presentation formats from within a main graphical display, according to an embodiment of the invention.

### DETAILED DESCRIPTION OF THE DRAWINGS

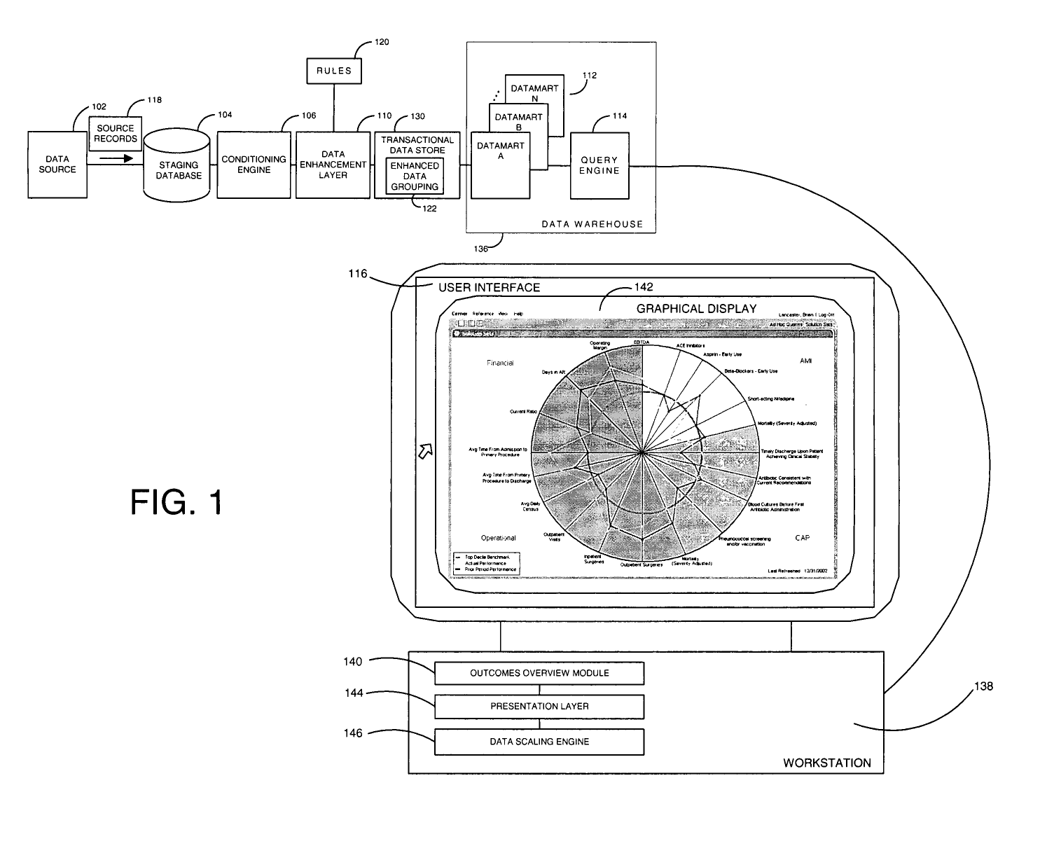

An illustrative environment in which a system and method for a management interface for clinical environments according to the invention may operate is illustrated in FIG. 1, in which a platform including an outcomes overview module 140 generates comparative analyses of clinically related data using one or more related or unrelated metrics via an integrated user interface 116. The user interface 116 may execute or be presented on a networked workstation 138 or other hardware. The user interface 116 may include or interface to graphical, textual, audio or other input and output devices, software and facilities, including for instance a mouse-driven graphical user interface, keyboard or other text or numeric input devices, CRT, LCD or other video displays, or other inputs or interfaces.

According to the invention in one regard, the outcomes overview module 140, a presentation layer 144 and other components may cooperate to generate a graphical display 142 via user interface 116. The graphical display 142 may selectively present commonly grouped clinically-related data in a common framework, including common scales as well as click-through tables and other data drilling options. The graphical display 142 may also in embodiments provide access to associated modeling engines and other tools to track and manage a variety of clinical operations. The graphical display 142 may as illustrated include any one or more of a spider or radar graph, pie chart, “breadcrumbs”, data tables or other statistically-based plots or other presentation or visualization frameworks or components.

The graphical display 142 may in embodiments enable users to view and manipulate interrelationships among various dissimilar metrics within a common framework, and in embodiments on a common scale. The graphical display 142 may accordingly depict data such as financial, clinical, pharmaceutical, department-level and other operational and other measures, as well as views on various analytics for that entire range of data. Those analytics may include reports on such details as variances from target performance and prior period's performance, on a circular chart with data traces as shown or in other presentation structures. Similar metrics may be organized into quadrants, deciles or other graphical sections which are normalized to common scales to allow users to compare the performance between key areas of interest or of key performance indicators (KPIs). For example, clinical outcomes, cost, supply and other data may be presented in quadrants, octants or other divisions which are scaled or normalized, for example to a 0-100%, decile or other scale.

As illustrated in FIG. 1 and elsewhere, normalized benchmarks may be presented via circular rings or other “isobar” or other reference points. As illustrated such demarcations on the graphical display 142 may indicate the dividing line between top decile or other levels of performance, and outliers. The pertinent units for individual sectors of the graphical display, such as mg/day for a drug prescription within the top decile or bottom 10% of recommended dosing, may for example appear when that sector is clicked, hovered over or linked to, or other action is taken. The graphical display 142 may likewise support access to tools for scenario modeling against standards-based treatment baselines, to determine if a change in treatment programs, procedures, pharmaceuticals or other parameters may improve patient outcomes and other metrics toward desired goals.

The outcomes overview module 140 and related logic may further facilitate access to supporting clinical and other data at higher or lower levels than those presented in graphical display 142. The outcomes overview module 140 in that regard may include the ability to perform one or more types of guided analysis. Such analytic views may be opened for example by viewing the linkage of one or more key performance indicator to multiple solution set metrics, selecting a quadrant's hyperlink to review all associated key performance indicators in a dashboard, or by selecting one point in elements in the graphical display 142 and drilling into a more detailed solution set metric.

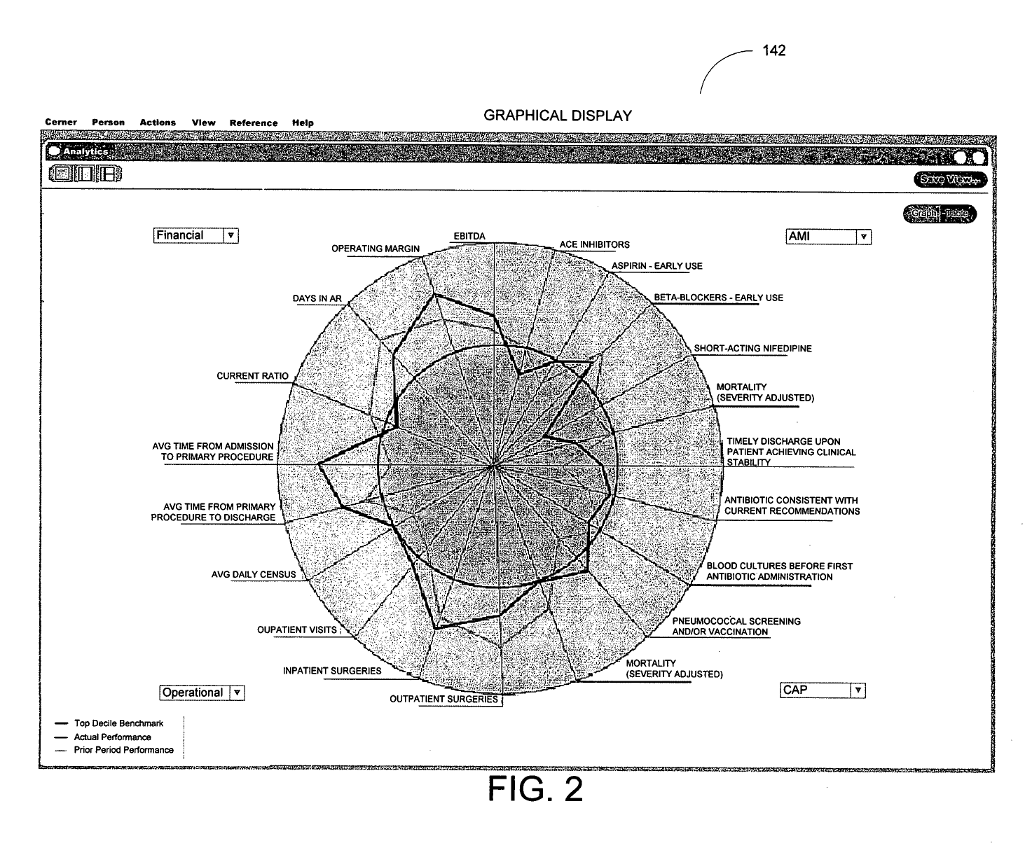

As illustrated in FIG. 2, in the clinical scenario illustratively presented on graphical display 142 the user can see that financially and operationally that results may be above a set target, such as a top-decile threshold (indicated by a circular ring). However, the user can also see that key performance indicators for Acute Myocardial Infarction (AMI) care are below target, within the same spider-style graph. Further review of graphical display 142 as illustrated shows that the mortality rate for AMI patients is below the target, and that the clinical data shown an abnormal rate of AMI patients receiving 80 mg/day or more of short-acting nifedipine. As also illustrated in FIG. 2, in embodiments of the invention the graphical display 142 may highlight regions of higher intensity or concern by way of increasingly dense color shade (illustratively red), to give the administrator or other user an immediate impression of data of interest.

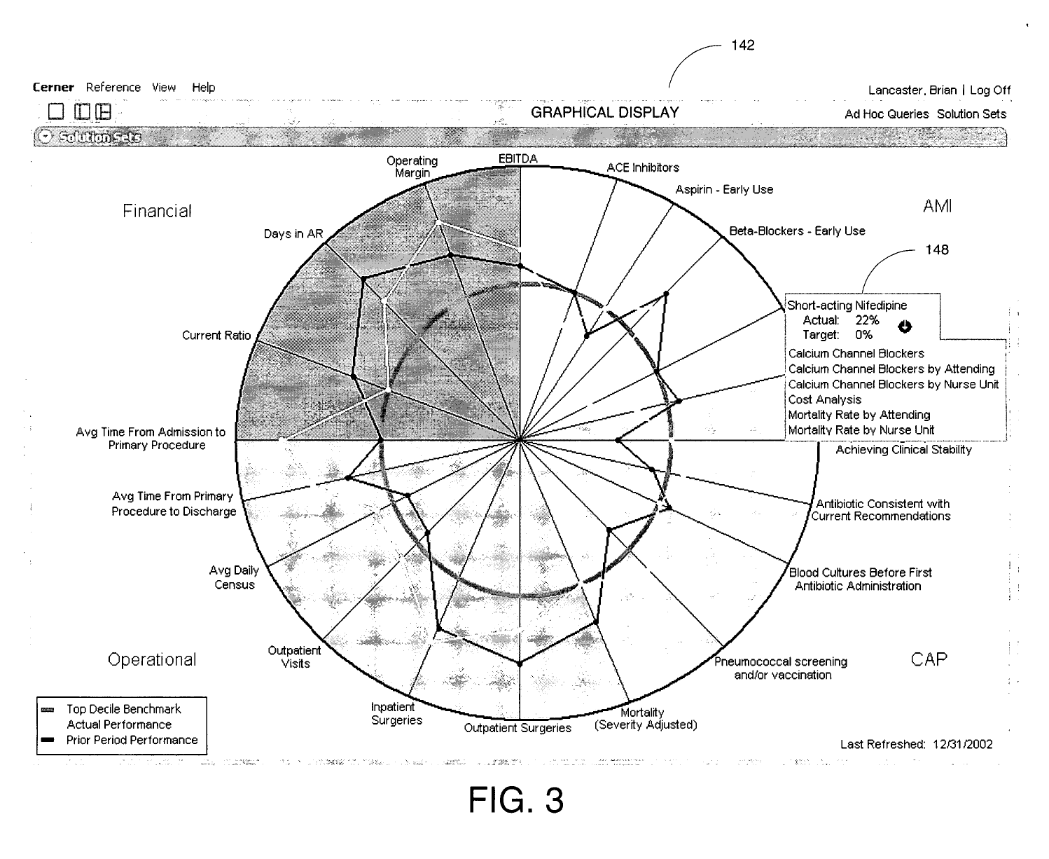

The clinical data grouped together in common scale and depicted in graphical display 142 may therefore alert the user, by such radial color gradients or otherwise, to examine aspects of the clinically-related data more closely. As illustrated in FIG. 3, a user may drill into selected data by clicking on an activatable icon 148, for instance an icon related to one or more key performance indicators presented within graphical display 142. Activation of the icon or other display element may trigger the display of all associated reports. An administrator, such as a chief medical officer or other user, can then review reports and decompose the data, for instance to sort by attending physician to see if the rate a drug or class of drugs is being prescribed is the same for all physicians, or if there are any outliers or other discernable patterns.

Users may also interact with the view presented in graphical display 142 by clicking on the quadrant name (for example, illustratively Financial, Operational, AMI or CAP) and hyperlinking to a dashboard view for that quadrant. Users may likewise or click on a point on the graph and hyperlink to an associated report. Other linkages and data are possible. According to embodiments of the invention in one regard, the ability to view interrelationships among diverse or dissimilar metrics, variances from target performance, prior period performance and to interact with the data is supported by the ability to flexibly group values of multiple facts. A data enhancement layer 110 which generates multidimensional extensions to original data may in one regard be employed to extract desired interrelationships and metrics, and present those results in graphical display 142.

According to the invention in another regard, the clinical and other data presented in graphical display 142 may be rendered by a presentation layer 144, and may be constructed from dimension and fact attribute associations. These associations may be represented in various control structures, such as analysis based data cubes, hierarchical groupings, multi-dimensional groupings such as those generated by data enhancement layer 110, relational assumptions, integrity based evaluations and other methodologies. Visual framework mechanisms may map rendering processes to constructs and then to defined control structures managed, for example, in a transactional data store 130 or other layer within a data warehousing or analytic engine. These mechanisms and associated data may also include multiple fact representations derived from underlying clinical, financial, operational and other data. In embodiments, data grouping engines and related functionality may be provided by engines such as those described in the aforementioned U.S. patent application Ser. No. 10/665,560 or others.

Multiple fact representations may be significant to the functional complements of outcomes overview. The ability to match more than one fact to identified control structures and extended or multiple dimensions may require or take advantage of a local or remote data scaling engine 146 which ensures aggregation and that changes in dimensions are readily managed by warehouse reporting solutions, such as standard query language (SQL) engines. The presentation layer 144 and other components may likewise enable the accurate interpretation of physical attribute representations, and provide a consistent visual rendering framework.

The association of multiple facts and related data aggregation may assume that representative content is controlled by physical structures within a prescribed architecture, with both attribute representation and core data when requirements implicate. Content and representation requirements may select any existing physical architecture. Implementation functionality is relative to rules surrounding structure of presentation layer content. Further assumptions which may be made to represent work-flow processes and physical structures include:

Physical representation of visual construction elements of the graph
Physical representation of graph related control structures
Physical representation of graph related attribute content
Physical representation of graph related data content
Physical representation of graph related implementation

Solution-based applications may resolve the manner and mechanisms responsible for the way data describing data (soft data) may be created, maintained and coupled to control structures, facts-dimension relationships and quantitative measures.

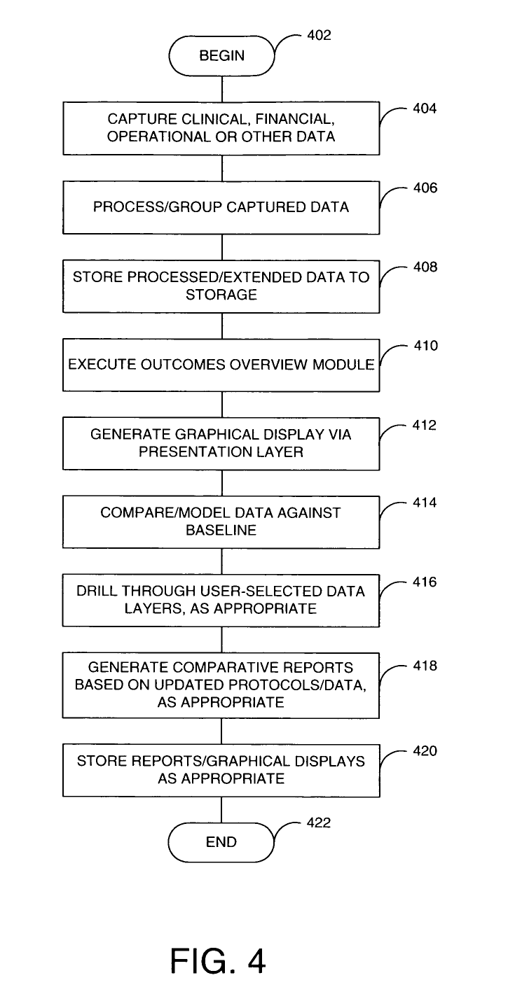

Overall processing according to an embodiment of the invention is illustrated in FIG. 4. In step 402, processing may begin. In step 404, clinical, financial, operational or other data may be captured from a hospital, university, government, research or other site. In step 406, the captured data may be conditioned and processed or extended, for instance by data enhancement layer 110 or other engines, for example to group or extend the dimensions of the data set using relationships between attributes or other factors. In step 408, the processed or extended clinical and other data may be stored to a data store, such as transactional data store 130 including one or more enhanced data grouping 122, which may be accessible via one or more datamart 112, query engine 114 and other resources.

In step 410, the outcomes overview module 140 and related logic may be executed to access, analyze and run reports against clinically related outcomes or results, for instance on a local or remote workstation 138. In step 412, a graphical display 142 or other output or presentation of clinical outcome and other data may be generated, for instance via presentation layer 144. In step 414, the clinical outcome or other data may be compared against medical, financial, operational or other baselines, for instance to determine whether patient recovery rates have reached a desired range or surgical procedures or pharmaceutical prescriptions conform to guidelines. In step 416, clinical outcome and other data may be examined at different layers according to user selection, as appropriate.

In step 418, comparative or other reports may be generated based on updated clinical protocols, policies or results, for instance to determine whether recovery rates or hospitals stays have improved quarter over quarter, for instance after updating clinical policies to standards or otherwise. In step 420, the graphical display 142 or other reports, models or other data may be stored to storage, for further access or analysis or other uses. In step 422, processing may repeat, return to a prior or other processing point, or end.

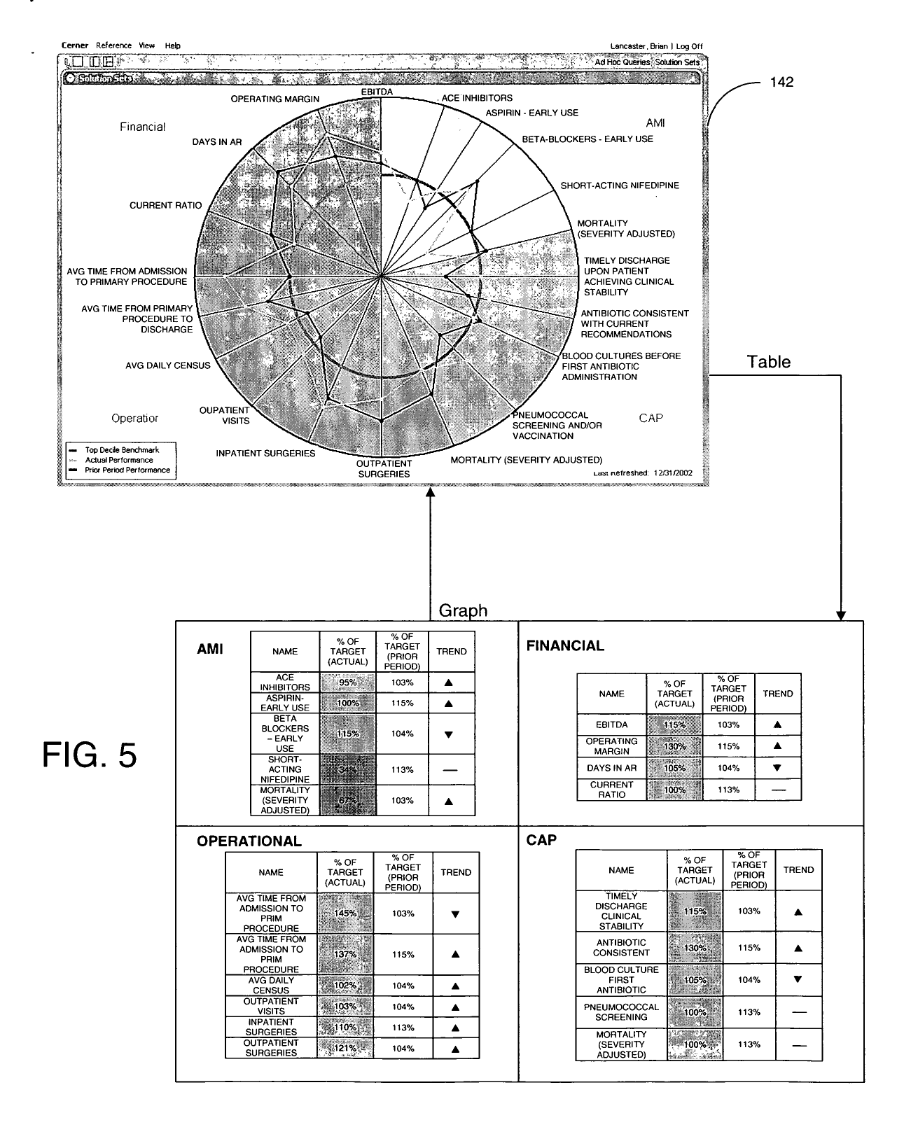

FIG. 5 illustrates a graphical display 142 operating according to embodiments of the invention, in another regard. As shown in that figure, in embodiments the administrator or other user may be presented with a graphical “spider-graph” type presentation of clinically related data, grouped in a common scale with different categories arranged in different quadrants or sectors, as in the presentation framework illustrated in FIG. 2 and elsewhere. In embodiments as illustrated in FIG. 5, the administrator or other user may be given the option to click into or otherwise activate key performance indicators or other access points within the main graphical display, and open out a new or concurrent display of further data related to the particular service line, clinical, financial or other measure they wish to view in further detail. In embodiments as shown, the expanded view on that deeper level data may be presented in a table format, rather than a graphical format as in the main display. Being able to view higher and lower levels of detail on data in diverse formats may permit an administrator or other user, for example, to visually or instinctively home in on areas of interest in the main graphical display, and drill into more detailed data in table or chart format. The administrator or other user may then return back to the main graphical display if desired, or proceed to further levels of table-based or other data if he or she prefers. Other viewing sequences are possible.

The foregoing description of a system and method for a management interface for clinical environments is illustrative, and variations in configuration and implementation will occur to persons skilled in the art. For instance, while the invention has generally been described as accessing data from one hospital or other facility to generate commonly grouped reports including outcomes and other data, in embodiments data may be collected and analyzed from multiple related or unrelated facilities.

For further example, while outcomes overview module 140 and other analytic tools have generally been described as executing on a single workstation 138, in embodiments that module and other software or logic may execute or be distributed amongst one or more local or remote computers or other platforms. For example the presentation layer 144 may be hosted on a client computer or other device while the outcomes overview module 140 may be hosted or may execute on a remote server or other resource. Other variations in configuration and implementation are possible. The scope of the invention is accordingly intended to be limited only by the following claims.

1. A system for generating an interface to clinical data, comprising:
an input interface to a set of clinically relevant source data;
an analytic engine, coupled with the input interface, the analytic engine generating reports based on at least the set of clinically relevant source data; and
a presentation layer, communicating with the analytic engine, the presentation layer generating a comparative display based on the set of clinically relevant source data and generated reports.

2. A system according to claim 1, wherein the comparative display comprises a graphical display.

3. A system according to claim 2, wherein the graphical display comprises a common scale.

4. A system according to claim 3, wherein the common scale comprises an isobar.

5. A system according to claim 2, wherein the graphical display comprises a color density gradient.

6. A system according to claim 1, wherein the comparative display comprises activatable data links.

7. A system according to claim 1, wherein the activatable data links generate a linked display of further clinically related data.

8. A system according to claim 7, wherein the further clinically related source data is presented in table format.

9. A system according to claim 7, wherein a user may traverse the comparative display and the linked display of further clinically related source data.

10. A system according to claim 1, wherein the presentation layer is hosted remotely from the analytic engine.

11. A method for generating an interface displaying clinical data, comprising:
receiving a set of clinically relevant source data;
generating reports based on at least the set of clinically relevant source data; and
generating a comparative display based on the set of clinically relevant source data and generated reports.

12. A method according to claim 11, wherein the comparative display comprises a graphical display.

13. A method according to claim 12, wherein the graphical display comprises a common scale.

14. A method according to claim 13, wherein the common scale comprises an isobar.

15. A method according to claim 12, wherein the graphical display comprises a color density gradient.

16. A method according to claim 11, wherein the comparative display comprises activatable data links.

17. A method according to claim 11, further comprising a step of generating a linked display of further clinically related data when the activatable links are activated.

18. A method according to claim 17, wherein the further clinically related source data is presented in table format.

19. A method according to claim 18, wherein a user may traverse the comparative display and the linked display of further clinically related source data.

20. A display of clinically related data, the display being generated by a method comprising:
receiving a set of clinically relevant source data;
generating reports based on at least the set of clinically relevant source data; and
generating a comparative display based on the set of clinically relevant source data and generated reports.

21. A display according to claim 20, wherein the comparative display comprises a graphical display.

22. A display according to claim 20, wherein the graphical display comprises a common scale.

23. A display according to claim 20, wherein the graphical display comprises a color density gradient.

24. A display according to claim 20, wherein the comparative display comprises activatable data links.

25. A display according to claim 24, wherein the method further comprises a step of generating a linked display of further clinically related data when the activatable links are activated.

26. A display according to claim 25, wherein the further clinically related source data is presented in table format.

27. A display according to claim 25, wherein a user may traverse the comparative display and the linked display of further clinically related source data.

28. A system for generating an interface to clinical data, comprising:
input means interfacing to a set of clinically relevant source data;
analytic means, coupled with the input means, the analytic means generating reports based on at least the set of clinically relevant source data; and
presentation means, communicating with the analytic means, the presentation means generating a comparative display based on the set of clinically relevant source data and generated reports.

29. A system according to claim 28, wherein the comparative display comprises a graphical display.

30. A system according to claim 29, wherein the graphical display comprises a common scale.

31. A system according to claim 28, wherein the comparative display comprises activatable data links.

32. A system according to claim 31, wherein the activatable data links generate a linked display of further clinically related data.
